(19) United States
(12) Patent Application Publication
(10) Pub. No.: US 2021/0061189 A1
(43) Pub. Date: Mar. 4, 2021

(54) DECORATIVE MEMBER AND COVER BODY OF MODULE

(71) Applicant: NIHON PLAST CO., LTD., Fujinomiya-shi (JP)

(72) Inventors: Takeshi Fujimori, Fujinomiya-shi (JP); Yohei Kiuchi, Fujinomiya-shi (JP)

(21) Appl. No.: 17/000,438

(22) Filed: Aug. 24, 2020

(30) Foreign Application Priority Data
Aug. 30, 2019 (JP) 2019-158566

(51) Int. Cl. B60R 13/00; B60Q 3/283; B60Q 3/85; B60R 21/215

(52) U.S. Cl. CPC B60R 13/005; B60Q 3/283; B60R 2021/21543; B60R 21/215; B60Q 3/85

(57) ABSTRACT

The present invention provides an emblem and a cover body of a module capable of suppressing light emission unevenness of an emblem body with a simple configuration. Emblem (20) includes emblem body (32) which includes a transmitting body (42) of which at least a portion has transmittance and non-transmitting body (43) which is a separate body from the transmitting body (42) and does not have the transmittance. Emblem (20) includes light source section (31) disposed between emblem body (32) and cover main body portion (19). Non-transmitting body (43) includes pin (51) which is inserted into opening portion (28) formed in the cover main body portion (19). Pin (51) is held on a rear surface side of cover main body portion (19), and thus, transmitting body (42) and light source section (31) are attached to cover main body portion (19) by non-transmitting body (43).

### CROSS REFERENCE TO RELATED APPLICATIONS

This application is entitled to and claims the benefit of Japanese Patent Application No. 2019-158566, filed on Aug. 30, 2019, the disclosure of which including the specification, drawings and abstract is incorporated herein by reference in its entity.

### TECHNICAL FIELD

The present invention relates to a decorative member having a light source section and a cover body of a module including the decorative member.

### BACKGROUND ART

In the related art, a module such as an airbag apparatus is attached to a steering wheel which is a handle for a vehicle such as an automobile. As a cover body of the module, a cover body is known in which an emblem (ornament) as a decorative member including an emblem body and a back plate is attached with a light source section and a cover main body portion interposed therebetween. In this configuration, the emblem body includes a transmitting portion through which light is transmitted and a non-transmitting portion through which light is not transmitted and a cylindrical locking pin having an enlarged portion at a distal end of the locking pin protrudes from a back surface side of the non-transmitting portion. The locking pin is locked to an engagement hole of the back plate engaging with the locking pin, and thus, the emblem body and the back plate engage with each other. Then, the light from the light source section causes a contour of the emblem body and the transmitting portion to emit light (for example, refer to PTL 1).

### CITATION LIST

### Patent Literature

### PTL 1

Japanese Patent Publication Laid-Open No. 2009-96450 (page 9, FIG. 14)

### SUMMARY OF INVENTION

### Technical Problem

In the case of the above-described configuration, in the emblem body, the transmitting portion and the non-transmitting portion are formed integrally with each other. Accordingly, there is a concern that an additional component may be added or a design of the emblem body may be limited to prevent the transmitting portion from being affected by light emission unevenness.

The present invention is made in consideration of the above-described circumstances, and an object thereof is to provide a decorative member capable of suppressing the light emission unevenness of a design portion with a simple configuration and a cover body of a module including the decorative member.

### Solution to Problem

According to a first aspect, there is provided a decorative member which is attached to an attached portion, the decorative member including: a design portion which includes a transmitting body of which at least a portion has transmittance and a non-transmitting body which is a separate body from the transmitting body and does not have the transmittance; and a light source section which is disposed between the design portion and the attached portion, in which the non-transmitting body includes a holding portion which is inserted into an opening portion formed in the attached portion, and the holding portion is held on a rear surface side of the attached portion, and thus, the transmitting body and the light source section are attached to the attached portion by the non-transmitting body.

According to the decorative member of a second aspect, in the decorative member according to the first aspect, the transmitting body has an opening into which the holding portion is inserted.

According to the decorative member of a third aspect, in the decorative member according to the first or second aspect, the holding portion has an engagement receiving portion, and a receiving portion is provided, which includes a hole portion into which the holding portion is inserted and a retaining section which prevents the holding portion from coming off from the hole portion via the engagement receiving portion, and holds the non-transmitting body on the rear surface side of the attached portion.

According to the decorative member of a fourth aspect, in the decorative member according to any one of the first to third aspects, the design portion includes a light adjustment section which adjusts an amount of light leaking from a gap between a contour and the attached portion.

According to a fifth aspect, there is provided a cover body for a module which is attached to a vehicle steering wheel, the cover body including: a cover main body portion which is an attached portion having an opening portion; and the decorative member according to any one of the first to fourth aspects.

According to the cover body of a module of a sixth aspect, in the cover body of a module according to the fifth aspect, the cover body is used for an airbag apparatus which is a module.

### Advantageous Effects of Invention

According to the decorative member of the first aspect, a shape of the transmitting body is simplified, and a passage of light from the light source section to the transmitting body is simplified by a simple configuration. Therefore, it is possible to suppress light emission unevenness of the design portion.

According to the decorative member of the second aspect, in addition to the effect of the decorative member of the first aspect, the transmitting body can be reliably pressed against the attached portion by the non-transmitting body at a position of a peripheral edge of the opening, and the decorative member can be firmly attached to attached portion.

According to the decorative member of the third aspect, in addition to the effect of the decorative member of the first or second aspect, the decorative member can be easily attached to the attached portion.

According to the decorative member of the fourth aspect, in addition to the effect of the decorative member according to any one of the first to third aspects, it is possible to suppress unevenness of light leaking from the contour of the design portion by the light adjustment section.

According to the cover body of a module of the fifth aspect, it is possible to provide a vehicle steering wheel including cover body with enhanced decorativeness by the decorative member which is inexpensive and in which transmitting body or the like emits light.

According to the cover body of a module of the sixth aspect, in addition to the effect of the cover body of a module of the fifth aspect, even when the decorative member is applied to a cover body of an airbag apparatus, the holding portion of the non-transmitting body is held on the rear surface side of the attached portion, and thus, it is possible to obtain a fixing structure of the decorative member having a sufficient holding force against a deployment pressure and impact of an airbag.

### BRIEF DESCRIPTION OF DRAWINGS

FIG. 1 is a partial cross-sectional view illustrating a decorative member according to Embodiment 1 of the present invention;

FIG. 2 is an exploded perspective view of the decorative member;

FIG. 3A is a plan view of a non-transmitting body of the decorative member, and

FIG. 3B is a side view of the non-transmitting body;

FIG. 4 is a front view illustrating a steering wheel including the cover body of a module having the decorative member;

FIG. 5A is a cross-sectional view of a portion of a decorative member according to Embodiment 2 of the present invention, FIG. 5B is a cross-sectional view of another portion of the decorative member, and FIG. 5C is a cross-sectional view of still another portion of the decorative member; and

FIG. 6 is a plan view of the decorative member.

### DESCRIPTION OF EMBODIMENTS

Hereinafter, Embodiment 1 of the present invention will be described with reference to the drawings.

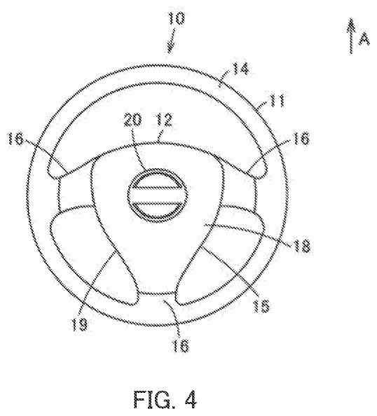

In FIG. 4, a reference numeral 10 indicates a steering wheel as a handle for an automobile which is a vehicle. Steering wheel 10 includes steering wheel body 11 which is a handle body, and module 12 which is mounted on an occupant side of steering wheel body 11. Steering wheel 10 is normally mounted on a steering shaft provided in a vehicle in a tilted state. However, hereinafter, based on a straight traveling state of the vehicle, the steering shaft side is referred to as a rear surface side, the occupant side is referred to as a front surface side, and a direction toward a windshield (a direction of arrow A) is referred to as an upper side.

Then, steering wheel body 11 includes rim portion 14 which is an annular gripper, boss portion 15 which is located inside rim portion 14, and plurality of spoke portions 16 which connect rim portion 14 and boss portion 15 to each other. Although three spoke portions 16 are illustrated in the present embodiment, the number of spoke portions 16 is not limited to three.

Although not illustrated, a substantially cylindrical boss fitted to the steering shaft is provided on a rear surface portion of boss portion 15, and a boss plate constituting a core is integrally fixed to the boss. Then, a core metal of spoke portion 16 is integrally extended from the boss plate or fixed to the boss plate by welding or the like. Moreover, a core metal of rim portion 14 is fixed to the core metal of spoke portion 16 by welding or the like. A skin portion is formed on an outer peripheral portion of the core metal of rim portion 14 and an outer peripheral portion of a portion of core metal of spoke portion 16 on rim portion 14 side, and the whole or portion of an outer periphery of the skin portion is covered with natural or artificial leather.

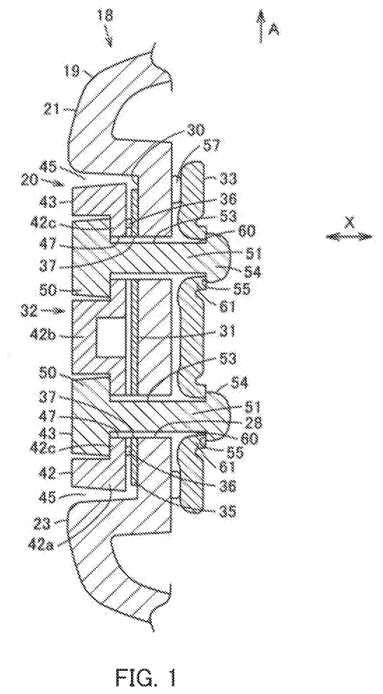

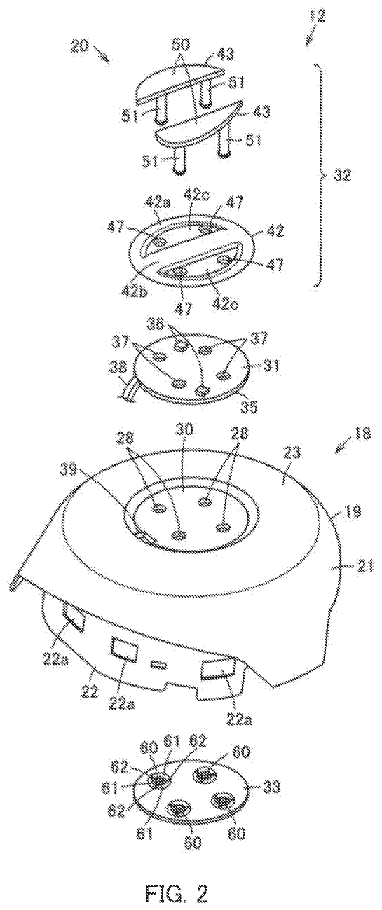

Meanwhile, module 12 is a shock absorbing apparatus in the present embodiment. Preferably, module 12 is an airbag apparatus. Module 12 is disposed so as to cover a front surface side of the boss portion of steering wheel body 11. In the present embodiment, module 12 includes a base plate as an attached member, a cushioning body, or the like, and also includes cover body 18 illustrated in FIGS. 1 and 2. When module 12 is an airbag apparatus, the cushioning body is a bag-shaped airbag, and module 12 further includes an inflator for inflating and deploying the airbag. Then, the base plate is attached to steering wheel body 11 (FIG. 4) via a horn plate or a bracket portion, and the cushioning body and cover body 18 are attached to the base plate.

Cover body 18 is also called a case body, a pad, a module cover, or the like. For example, cover body 18 includes cover main body portion 19 which is an attached portion and emblem 20 which is a decorative member attached to cover main body portion 19.

For example, cover main body portion 19 is made of a synthetic resin. The cover main body portion 19 includes front plate portion 21 as a covering portion which covers a portion of boss portion 15 and spoke portions 16 (FIG. 4), and peripheral plate portion 22 which is a peripheral wall protruding in a substantially rectangular tube shape in a front view from a rear surface (back surface) of front plate portion 21. A portion surrounded by front plate portion 21 and peripheral plate portion 22 is a storage section which stores the cushioning body, that is, a folded airbag in the present embodiment, and a portion facing a front surface side of the storage section is front surface plate portion 23 which is a decorative member attachment section facing an occupant of a driving seat. In the present embodiment, a tear line (not illustrated) facing the storage section is formed on front plate portion 21, and a plurality of doors are formed on front plate portion 21 when the tear line is torn and the airbag is deployed. The tear line can also be called a planned line portion or a breakable portion, is formed in a groove shape on a rear surface (back surface) side of front surface plate portion 23, and is a weak portion weaker than other portions of front surface plate portion 23. The tear line can be set at any position avoiding emblem 20 according to shapes and the number of doors to be set.

Front plate portion 21 has opening portion 28 for attaching emblem 20. Opening portion 28 is formed in a circular shape, and penetrates front surface plate portion 23 in a front-rear direction which is a thickness direction. As long as opening portion 28 can fix emblem 20 up, down, right, and left in a well-balanced manner, one opening portion 28 or plurality of opening portions 28 can be appropriately set according to a shape and the like thereof. In the present embodiment, four opening portions 28 are formed, for example. In the illustrated example, opening portions 28 are disposed on front plate portion 21 (front surface plate portion 23) of cover main body portion 19, two opening portions 28 are disposed on right and left sides, and two opening portions 28 are disposed on upper and lower sides. Opening portions 28 are disposed vertically and horizontally symmetrically or substantially symmetrically. Front plate portion 21 may include attachment recessed portion 30 as a decorative member storage section in which emblem 20 is stored, at a center portion on the front surface side which is a design surface. For example, attachment recessed portion 30 is formed along the shape of emblem 20. In this case, opening portion 28 is disposed on a bottom of attachment recessed portion 30.

As illustrated in FIG. 2, peripheral plate portion 22 includes plurality of engaging openings 22a which are cover body engaging portions for engaging the base plate and cover body 18.

Emblem 20 illustrated in FIGS. 1 and 2 is also called an ornament or the like. Emblem 20 includes light source section 31 and emblem body 32 which is a design portion illuminated by light source section 31. In the present embodiment, emblem 20 further includes back plate 33 which is a receiving portion. Emblem 20 is attached so that front plate portion 21 (front surface plate portion 23) of cover main body portion 19 of cover body 18 is interposed between emblem body 32, light source section 31, and back plate 33.

Light source section 31 is interposed and held between emblem body 32 and front plate portion 21 (front surface plate portion 23) of cover main body portion 19. Light source section 31 includes substrate portion 35 and light source body 36 which is mounted on substrate portion 35. Substrate portion 35 is formed in a plate shape. A circuit, a wire, or the like may be mounted on substrate portion 35. Substrate portion 35 is overlapped with a front surface side of front plate portion 21 (front surface plate portion 23) of cover main body portion 19. Substrate portion 35 may have various shapes depending on a shape of emblem body 32 to be illuminated. For example, in the present embodiment, substrate portion 35 is formed in a substantially circular shape or a substantially elliptical shape. In the present embodiment, substrate portion 35 is overlapped with a bottom of attachment recessed portion 30. That is, attachment recessed portion 30 is formed in a circular shape or an elliptical shape. In the present embodiment, light source section 31 includes opening 37. Opening 37 is formed in substrate portion 35. Opening 37 is formed in a round hole shape, for example. Opening 37 is formed to penetrate substrate portion 35 in a thickness direction. Opening 37 is formed corresponding to opening portion 28. That is, in the present embodiment, four openings 37 are formed. In the illustrated example, two openings 37 are disposed on the right and left sides and two openings 37 are disposed on the upper and lower sides.

Light source body 36 is a light emitting body such as an LED or an organic EL element. Light source body 36 is mounted on a surface side of substrate portion 35. Light source body 36 may be disposed at any position on the surface of substrate portion 35 according to a design of emblem body 32. However, in the present embodiment, two light source bodies 36 are provided, one is disposed on an upper side on a surface of substrate portion 35, and the other is disposed on a lower side thereof. Power and a signal for turning on light source body 36 are supplied to light source body 36. In the present embodiment, the power and signal to light source body 36 are supplied from a vehicle body side. Therefore, in the present embodiment, light source section 31 includes connection section 38 which is electrically connected to the vehicle body side. The connection section 38 is a cable such as a flat cable. That is, light source section 31 is wire-connected to the vehicle body side. Connection section 38 extends from an edge portion of substrate portion 35. Connection section 38 is inserted into insertion opening portion 39 formed in front plate portion 21 (front surface plate portion 23) of cover main body portion 19 and introduced into cover body 18. In the present embodiment, for example, insertion opening portion 39 is formed in attachment recessed portion 30, and is covered with emblem body 32 so that insertion opening portion 39 cannot be seen from an occupant side.

Emblem body 32 is also called a design ornament, an upper plate, an upper emblem, or the like, and constitutes a design portion of emblem 20. Emblem body 32 is attached to a front surface side of front surface plate portion 23 which is a side opposite to the airbag. In the present embodiment, emblem body 32 is fitted into attachment recessed portion 30.

Emblem body 32 includes transmitting body 42 of which at least a portion has transmittance, that is, through which light is transmitted, and non-transmitting body 43 which does not have transmittance, that is, through which light is not transmitted.

In the present embodiment, transmitting body 42 is a main decorative portion which constitutes a main portion or most of emblem body 32. For example, transmitting body 42 is formed of a hard or soft synthetic resin, and is subjected to a surface treatment such as appropriate painting. Transmitting body 42 can have various shapes. However, in the present embodiment, for example, transmitting body 42 has a substantially circular or elliptical outer shape. For example, transmitting body 42 includes substantially circular annular portion 42a which forms an outer edge portion, crossing portion 42b which crosses annular portion 42a in a radial direction, and covering portions 42c which covers a portion between annular portion 42a and crossing portion 42b. Covering portion 42c is a portion which is covered with non-transmitting body 43 and is pressed against cover main body portion 19. In the present embodiment, covering portions 42c are disposed on both sides of crossing portion 42b as a reference. In the illustrated example, covering portions 42c are disposed above and below crossing portion 42b, respectively. In the present embodiment, transmitting body 42 is formed to be vertically symmetrical. In the present embodiment, transmitting body 42 is fitted into attachment recessed portion 30. The outer edge portion of transmitting body 42 is disposed along an inner edge portion of attachment recessed portion 30. Predetermined gap 45 is formed between the outer edge portion of transmitting body 42 and the inner edge portion of attachment recessed portion 30. Transmitting body 42 is formed in a plate shape. Transmitting body 42 is located at a position facing light source body 36 of light source section 31 in front and rear directions. In the present embodiment, transmitting body 42 faces light source body 36 at least at a position excluding covering portions 42c.

In the present embodiment, transmitting body 42 includes openings 47. For example, each opening 47 is formed in a round hole shape. Opening 47 is formed to penetrate transmitting body 42 in a thickness direction. Opening 47 is formed in a portion covered by non-transmitting body 43. In the present embodiment, opening 47 is formed in covering portion 42c. Opening 47 is formed corresponding to opening portion 28 and opening 37 of light source section 31. That is, in the present embodiment, four openings 47 are formed. In the illustrated example, two openings 47 are disposed on the right and left sides and two openings 47 are disposed on the upper and lower sides. In the present embodiment, two openings 47 are formed for each covering portion 42c.

Light may be transmitted via entire transmitting body 42, or light may be partially transmitted via transmitting body 42. For example, even if transmitting body 42 is formed of a synthetic resin having transmittance, a portion through which light is transmitted may be limited by a surface treatment such as painting or plating depending on a design. Light transparency of transmitting body 42 does not need to be constant as a whole, and the light transparency may be intentionally made large or small by the surface treatment or the like depending on the design.

Non-transmitting body 43 is a sub-decoration portion which constitutes the remaining portion of emblem body 32 in the present embodiment. Non-transmitting body 43 integrally includes non-transmitting body main body 50 and pins 51 which are holding portions. Non-transmitting body main body 50 can have various shapes. For example, in the present embodiment, non-transmitting body main body 50 has a substantially semicircular or semielliptical outer shape. For example, non-transmitting body main body 50 is formed in a shape which covers covering portion 42c of transmitting body 42. The number of non-transmitting bodies 43 may be set according to a design of emblem body 32. For example, in the present embodiment, pair of non-transmitting bodies 43 is formed. Non-transmitting body main bodies 50 are vertically or symmetrically disposed with a center portion or crossing portion 42b of transmitting body 42 interposed therebetween. Non-transmitting body main body 50 is formed in a plate shape.

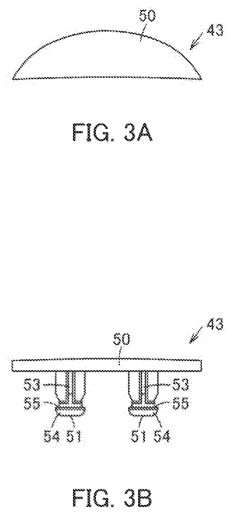

Each pin 51 is inserted into openings 37 and 47 and opening portion 28 and engages with back plate 33. Accordingly, emblem body 32 and light source section 31 engage with and are fixed to back plate 33 located on cover main body portion 19 side. As illustrated in FIGS. 1, 3A and 3B, each pin 51 has shaft portion 53 which is continuous with non-transmitting body main body 50 and enlarged portion 54 which is formed on a distal side of shaft portion 53 and is enlarged in a step shape. Here, the number and dispositions of pins 51 can be appropriately set according to shapes thereof or the like as long as emblem body 32 can be supported vertically and horizontally in a well-balanced manner according to a design of emblem body 32. In the present embodiment, for example, plurality of pins 51 are disposed on non-transmitting body 43. In the illustrated example, two pins 51 are disposed for each non-transmitting body 43.

Shaft portion 53 is formed to have a thickness which allows shaft portion 53 to be inserted into opening portion 28 of cover main body portion 19. In the present embodiment, shaft portion 53 is formed to have a thickness which allows shaft portion 53 to be inserted into opening 47 of transmitting body 42 and opening 37 of light source section 31. Shaft portion 53 is provided on a rear surface side of non-transmitting body main body 50 so as to protrude in a thickness direction of non-transmitting body main body 50. A rib may be formed on an outer surface of shaft portion 53 along an axial direction, that is, a protrusion direction.

Enlarged portion 54 is enlarged with respect to shaft portion 53 in a direction intersecting the protrusion direction of pin 51. Enlarged portion 54 is formed to have a thickness which allows enlarged portion 54 to be inserted into opening portion 28 of cover main body portion 19. In the present embodiment, enlarged portion 54 is formed to have a thickness which allows enlarged portion 54 to be inserted into opening 47 of transmitting body 42 and opening 37 of light source section 31. Engagement receiving portion 55 which engages with back plate 33 is formed on enlarged portion 54 on non-transmitting body main body 50 side. Engagement receiving portion 55 is formed in a planar shape along a direction intersecting an insertion/removal direction of pin 51 into/from opening portion 28. Engagement receiving portion 55 has an undercut shape when viewed from an insertion side of pin 51.

Back plate 33 illustrated in FIGS. 1 and 2 is also called a lower emblem or the like. For example, back plate 33 is made of a hard synthetic resin. Back plate 33 can have various shapes as long as emblem body 32 can be fixed to front plate portion 21 (front surface plate portion 23) of cover main body portion 19. However, in the present embodiment, for example, back plate 33 is formed in an oval or elliptical shape having a long axis direction in a right-left direction. Back plate 33 is attached to a rear surface side which is the airbag side of front surface plate portion 23. In the present embodiment, back plate 33 is disposed on a rear surface side of attachment recessed portion 30. Back plate 33 abuts on support portion 57 with respect to front plate portion 21 (front surface plate portion 23) of cover main body portion 19. Support portion 57 protrudes in a rib shape on a rear surface side of front plate portion 21 (front surface plate portion 23).

Back plate 33 includes hole portions 60 into which pins 51 of emblem body 32 are respectively inserted. Each hole portion 60 is formed so as to penetrate the back plate 33 in the thickness direction. For example, hole portion 60 is formed in a circular shape. Hole portion 60 is disposed corresponding to the dispositions of pins 51. In the present embodiment, plurality of hole portions 60 are disposed in back plate 33. In the illustrated example, four hole portions 60 are disposed in back plate 33. For example, two hole portions 60 are disposed on the right and left sides and two hole portions 60 are disposed on the upper and lower sides. Hole portion 60 has an outer shape which is larger than that of shaft portion 53 of pin 51 and smaller than that of enlarged portion 54.

Retaining section 61 for locking inserted pin 51 is formed in hole portion 60. Retaining section 61 is a claw portion formed on an inner edge of hole portion 60. Retaining section 61 has a thickness direction in the insertion/removal direction (indicated by arrow X) of pin 51 with respect to hole portion 60, which is the protrusion direction of pin 51, and has a plate shape which is elastically deformable in this thickness direction. In the present embodiment, three retaining sections 61 are formed in hole portion 60 and are equally spaced apart from each other in a circumferential direction of hole portion 60. Therefore, cutout portion 62, which is a radial groove portion, is formed along a radial direction of hole portion 60 between adjacent retaining sections 61 and 61. Therefore, in the present embodiment, three cutout portions 62 are formed in hole portion 60.

Retaining section 61 engages with engagement receiving portion 55 of pin 51 to lock emblem body 32 to back plate 33 and facilitates insertion of pin 51 into hole portion 60. For example, retaining section 61 is formed in a shape of a band which constantly protrudes from an inner edge of hole portion 60 along the circumferential direction. Retaining section 61 is curved from a proximal portion toward a distal portion along the insertion/removal direction of pin 51 into/from hole portion 60.

Then, when cover body 18 is manufactured, after cover main body portion 19 is injection-molded with a synthetic resin in advance, light source section 31 in which light source body 36 is mounted on substrate portion 35 is overlapped with the front surface side of front surface plate portion 23 of front plate portion 21 of cover main body portion 19 at the position of attachment recessed portion 30 while connection section 38 is inserted into insertion opening portion 39 to be connected to the vehicle body side, and openings 37 are aligned with opening portions 28 of cover main body portion 19. Next, transmitting body 42 of emblem body 32 which is separately molded is disposed on the front surface side of light source section 31, and openings 47 are aligned with openings 37 of light source section 31. Moreover, non-transmitting bodies 43 are further disposed on the front surface side of transmitting body 42, pins 51 are inserted through openings 47, openings 37, and opening portions 28, separately molded back plate 33 is disposed on the rear surface side of front surface plate portion 23 of front plate portion 21, and pins 51 of non-transmitting body 43 protruding from opening portions 28 are fitted (press-fitted) into hole portions 60 of back plate 33. As a result, enlarged portions 54 of pins 51 elastically deforms retaining sections 61, retaining sections 61 are deformed to be returned at positions where enlarged portions 54 have passed through retaining sections 61, and retaining sections 61 abut on engagement receiving portion 55. Accordingly, retaining of pins 51 is maintained. Therefore, emblem body 32 and back plate 33 firmly fix emblem 20 to cover body 18 in a state where front surface plate portion 23 of front plate portion 21 and light source section 31 are disposed therebetween in the front and rear directions.

When power is supplied to light source body 36 of light source section 31 to emit light, the light from light source body 36 passes through transmitting body 42 to the occupant side, and the light is emitted to the occupant side to illuminate a contour of emblem body 32 (transmitting body 42) from gap 45. Accordingly, emblem body 32 is decorated.

In the present embodiment, if an automobile including module 12 having cover body 18 in steering wheel 10 collides, a control apparatus operates an inflator to supply gas to the airbag. Then, the airbag is rapidly inflated and deployed, front plate portion 21 of cover main body portion 19 is broken along the tear line at a position bypassing emblem 20 by a pressure caused by the inflation and deployment to form the door. The door portion is turned around a hinge portion to form a protrusion opening which is an opening for inflating the airbag, and the airbag is deployed in front of the occupant from the protrusion opening to protect the occupant. In this case, retaining sections 61 of pins 51 of non-transmitting body 43 firmly abut on engagement receiving portion 55, and prevents emblem 20 from falling off from cover main body portion 19 due to the deployment pressure of the airbag.

As described above, according to Embodiment 1, transmitting body 42 and non-transmitting bodies 43 are separate bodies, pins 51 provided in each non-transmitting body 43 is held on the rear surface side of cover main body portion 19, and transmitting body 42 and light source section 31 are attached to cover main body portion 19 by non-transmitting bodies 43. Accordingly, compared to a case where the pin is provided in transmitting body 42, a shape of transmitting body 42 is simplified, and the passage of the light from light source section 31 to transmitting body 42 is simplified by a simple configuration. Therefore, it is possible to provide thin emblem 20 capable of suppressing irregular reflection and interference of the light caused by the shape of transmitting body 42 and suppressing light emission unevenness of emblem body 32.

Moreover, a portion (covering portion 42c) of transmitting body 42 is pressed by non-transmitting body 43 and is attached to cover main body portion 19. Accordingly, the portion (covering portion 42c) pressed by non-transmitting body 43 is provided in transmitting body 42, and thus, a strength of a single piece of transmitting body 42 can be improved.

In particular, openings 47 into which pins 51 of non-transmitting body 43 are inserted are formed in transmitting body 42. Accordingly, transmitting body 42 can be reliably pressed against cover main body portion 19 by non-transmitting bodies 43 at positions of peripheral edges of openings 47, in the present embodiment, at covering portions 42c, and emblem 20 can be firmly attached to cover main body portion 19.

Back plate 33 disposed on the rear surface side of cover main body portion 19 includes hole portions 60 into which pins 51 are inserted, and retaining sections 61 for preventing pins 51 from coming off from hole portions 60 via engagement receiving portions 55. Accordingly, non-transmitting bodies 43 can be easily held by being attached to back plate 33 and held, and emblem 20 can be easily attached to cover main body portion 19 with one touch.

By applying emblem 20 to cover body 18 of module 12 attached to vehicle steering wheel 10, it is possible to provide vehicle steering wheel 10 including cover body 18 with enhanced decorativeness by emblem 20 which is inexpensive and in which transmitting body 42 or the like emits light.

In particular, in a case where module 12 is an airbag apparatus, even when emblem 20 is applied to cover body 18 of the airbag apparatus, pins 51 of non-transmitting bodies 43 are held on the rear surface side of cover main body portion 19, and thus, it is possible to obtain a fixing structure of emblem 20 having a sufficient holding force against a deployment pressure and impact of the airbag.

Emblem 20 can be attached from the front surface side of cover body 18, a degree of freedom in a shape of emblem 20 can be improved and a design thereof can be improved.

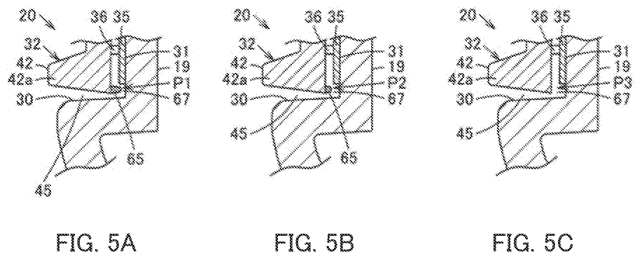

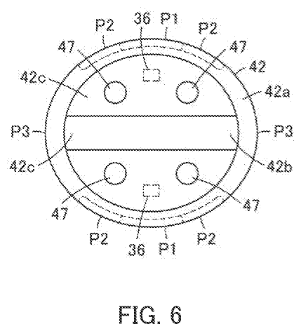

Next, Embodiment 2 will be described with reference to FIGS. 5A to 6. Components and operations similar to those in Embodiment 1 described above are designated by the reference signs and descriptions thereof will be omitted.

In emblem 20 of the present embodiment, emblem body 32 includes light adjustment section 65 for adjusting an amount of light leaking from a gap between a contour and cover main body portion 19. In the present embodiment, light adjustment section 65 adjusts an amount of light leaking from gap 45 to a position of a contour on an outer edge portion side of emblem body 32. However, according to the design of emblem 20, light adjustment section 65 may adjust an amount of light leaking from gap 45 to a position of a contour on an inner edge portion side of emblem 20.

Light adjustment section 65 adjusts an amount of light by adjusting a size of gap 67 between the rear surface side of emblem body 32 and cover main body portion 19. That is, light adjustment section 65 adjusts the amount of light leaking from gap 45 according to an amount of protrusion from emblem body 32. In the present embodiment, light adjustment section 65 is set so that the amount of light leaking from gap 45 decreases as the amount of protrusion increases. Light adjustment section 65 is a protrusion portion which protrudes from the rear surface side of emblem body 32 toward cover main body portion 19. For example, light adjustment section 65 is formed in a rib shape or a bead shape. Light adjustment section 65 is formed continuously or intermittently along a shape of the edge portion of emblem body 32. Light adjustment section 65 is formed on at least one of transmitting body 42 and non-transmitting body 43 of emblem body 32. In the present embodiment, light adjustment section 65 is formed on transmitting body 42. Light adjustment section 65 is provided on the rear surface side of transmitting body 42 to protrude along the shape of the outer edge portion of annular portion 42a of transmitting body 42.

Light adjustment section 65 may discretionally adjust the amount of light leaking from the outer edge portion of transmitting body 42 for each portion according to the design of emblem body 32. Therefore, light adjustment section 65 may have a constant amount of protrusion from transmitting body 42, or may have a different amount of protrusion depending on a position.

For example, in the present embodiment, in light adjustment section 65, position P1 (FIG. 5A) where the amount of protrusion is large and gap 67 is small and position P2 (FIG. 5B) where the amount of protrusion is small and gap 67 is large are set. Further, position P3 (FIG. 5C) where light adjustment section 65 is not provided is a position where the amount of leaking light is the largest. As illustrated in FIG. 6, for example, positions P1 are set in areas including a center portion in the right-left direction at the outer edge portion of annular portion 42a of transmitting body 42. Positions P2 are set on both sides of position P1 along the outer edge portion of annular portion 42a. Further, positions P3 are set in an up-down direction in both right and left regions including positions of annular portion 42a which are continuous with crossing portion 42b.

Depending on the shape of emblem body 32, an intensity of light leaking from a joint portion between emblem body 32 and cover main body portion 19, that is, a gap between the contour of emblem body 32 and cover main body portion 19 may be changed, and unevenness of the intensity may occur. Therefore, in the present embodiment, by setting gap 67 between emblem body 32 and cover main body portion 19 by light adjustment section 65, the amount of light leaking from gap 45 is adjusted by light adjustment section 65. As a result, without increasing the number of light source bodies 36 of light source section 31, it is possible to suppress the unevenness of the light leaking from the contour of emblem body 32 by light adjustment section 65, and it is possible to perform illumination inexpensively and beautifully and to improve the design.

Further, light adjustment section 65 can easily control the leakage amount of light according to the amount of protrusion.

In each of the embodiments, engagement receiving portion 55 is not limited to being formed on non-transmitting body main body 50 side of enlarged portion 54. For example, engagement receiving portion 55 may be formed in pin 51 to have a groove shape recessed in a direction intersecting the protrusion direction of pin 51.

Emblem 20 can be embodied regardless of the shape thereof and the number of pins 51 as long as a mold structure of emblem 20 is established.

Pin 51 may be welded to and held by back plate 33, or pin 51 may be directly welded to cover main body portion 19 without using back plate 33. That is, emblem body 32 (non-transmitting body 43) is not limited to being locked to and held by back plate 33, and back plate 33 is not an essential component.

Depending on the shapes of emblem body 32 and light source section 31, at least one of opening 37 and opening 47 may be unnecessary. For example, in a case where a pressing portion which presses the peripheral edge of light source section 31 (substrate portion 35) is formed on transmitting body 42, non-transmitting body 43 presses transmitting body 42 against cover main body portion 19, and light source section 31 can be indirectly pressed to cover main body portion 19. Accordingly, it is not necessary to form openings 37 into which pins 51 are inserted in light source section 31. Similarly, in a case where a transmitting body pressing portion which presses the peripheral edge of transmitting body 42 is formed on non-transmitting body main body 50 of non-transmitting body 43, it is not necessary to form openings 47 into which pins 51 are inserted in transmitting body 42.

Furthermore, module 12 may be configured without an airbag. For example, instead of the airbag, a shock absorbing body such as an EA body may be used as a cushioning body.

Further, module 12 is not limited to including the cushioning body, and for example, may be a horn pad or the like for operating a horn operating apparatus provided in steering wheel 10.

### INDUSTRIAL APPLICABILITY

For example, the present invention can be applied to a cover body of an airbag apparatus as a module used for a steering wheel of an automobile, or an emblem attached to other members.

### REFERENCE SIGNS LIST

10 Steering wheel

12 Module

18 Cover body

19 Cover main body portion which is attached portion

20 Emblem which is decorative member

28 Opening portion

31 Light source section

32 Emblem body which is design portion

33 Back plate which is receiving portion

42 Transmitting body

43 Non-transmitting body

45 Gap

47 Opening

51 Pin which is holding portion

55 Engagement receiving portion

60 Hole portion

61 Retaining section

65 Light adjustment section

1. A decorative member which is attached to an attached portion, the decorative member comprising:
a design portion which includes a transmitting body of which at least a portion has transmittance body and a non-transmitting body which is a separate body from the transmitting body and does not have transmittance; and
a light source section which is disposed between the design portion and the attached portion,
wherein the non-transmitting body includes a holding portion which is inserted into an opening portion formed in the attached portion, and
wherein the holding portion is held on a rear surface side of the attached portion, and thus, the transmitting body and the light source section are attached to the attached portion by the non-transmitting body.

2. The decorative member according to claim 1,
wherein the transmitting body has an opening into which the holding portion is inserted.

3. The decorative member according to claim 1,
wherein the holding portion has an engagement receiving portion, and
wherein a receiving portion is provided, which includes a hole portion into which the holding portion is inserted and a retaining section which prevents the holding portion from coming off from the hole portion via the engagement receiving portion, and holds the non-transmitting body on the rear surface side of the attached portion.

4. The decorative member according to claim 1,
wherein the design portion includes a light adjustment section which adjusts an amount of light leaking from a gap between a contour and the attached portion.

5. A cover body for a module which is attached to a vehicle steering wheel, the cover body comprising:
a cover main body portion which is an attached portion having an opening portion; and
the decorative member according to claim 1.

6. The cover body for a module according to claim 5,
wherein the cover body is used for an airbag apparatus which is a module.
